(19) United States
(12) Patent Application Publication
(10) Pub. No.: US 2024/0186727 A1
(43) Pub. Date: Jun. 6, 2024

(54) TERMINAL BLOCK

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Yuta HOSOYA, Yokkaichi-shi (JP); Daisuke HASHIMOTO, Yokkaichi-shi (JP); Yoshitomo TSUJII, Yokkaichi-shi (JP); Toshiaki INOUE, Yokkaichi-shi (JP); Tetsuya IIDA, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 18/283,280

(22) PCT Filed: Mar. 17, 2022
(86) PCT No.: PCT/JP2022/012357

§ 371 Date: Sep. 21, 2023

(30) Foreign Application Priority Data
Apr. 9, 2021 (JP) 2021-066205

(51) Int. Cl. H01R 9/24

(52) U.S. Cl. CPC H01R 9/24

(57) ABSTRACT

A terminal block that includes: a main body made of resin; and a terminal partly molded into the main body, wherein the terminal includes: a first hole extending through a first portion that protrudes outward from one surface of the main body in an inclined direction intersecting both a vertical direction and a horizontal direction; and a second hole extending through a second portion that spans from an inside of the main body to the first hole in one of the vertical direction and the horizontal direction.

### BACKGROUND

The present disclosure relates to a terminal block.

The terminal block described in JP 2017-117643A includes a resin main body and a terminal formed by a bus bar. An intermediate portion of the terminal is molded into the main body through insert molding.

### SUMMARY

The terminal may have a hole in a portion protruding outwardly from the main body. The hole of the terminal can be a fastening hole through which a fastening member such as a bolt is inserted. When the hole of the terminal is a fastening hole, positional accuracy of the hole of the terminal needs to be increased.

When the terminal block is formed through insert molding, the terminal can be positioned by passing a positioning pin through the hole of the terminal. The positional accuracy of the hole of the terminal can be ensured by positioning using the positioning pin.

The positioning pin normally protrudes in the same vertical direction as a movement direction of a movable upper mold or in a horizontal direction perpendicular to the vertical direction, and is passed through the hole of the terminal. In contrast, when the extension direction of the hole of the terminal is oriented in an inclined direction intersecting both the vertical direction and the horizontal direction, there is a problem that the positioning pin cannot be passed through the hole of the terminal.

An exemplary aspect of the disclosure provides a terminal block capable of ensuring the positional accuracy of the hole of the terminal.

A terminal block of the present disclosure includes a main body made of resin and a terminal partly molded into the main body, wherein the terminal has a first hole extending through a first portion that protrudes outward from one surface of the main body in an inclined direction intersecting both a vertical direction and a horizontal direction, and a second hole extending through a second portion that spans from an inside of the main body to the first hole in one of the vertical direction and the horizontal direction.

According to the present disclosure, it is possible to provide a terminal block capable of ensuring positional accuracy of the hole of the terminal.

### BRIEF DESCRIPTION OF THE DRAWINGS

FIG. 1 is a side view of a terminal block according to the present embodiment.

FIG. 2 is a cross-sectional view of the terminal block.

FIG. 3 is a cross-sectional view of an intermediate assembly in which a primary molded portion and a terminal are integrated.

FIG. 4 is a cross-sectional view for explaining insert molding.

### DETAILED DESCRIPTION OF EMBODIMENTS

### Description of Embodiments of Present Disclosure

First, embodiments of the present disclosure will be listed and described.

A terminal block of the present disclosure

(1) includes a main body made of resin and a terminal partly molded into the main body, wherein the terminal has a first hole extending through a portion protruding outward from one surface of the main body in an inclined direction intersecting both a vertical direction and a horizontal direction, and a second hole extending through a portion spanning from the inside of the main body to the first hole in one of the vertical direction and the horizontal direction.

A portion of the terminal is molded into the main body through insert molding. A mold for insert molding can have a positioning pin protruding in one of the vertical direction and the horizontal direction. Therefore, when insert molding is performed, the positioning pin can be passed through the second hole open in a protruding direction of the positioning pin to position the terminal. The second hole is disposed in a portion spanning from the inside of the main body to the first hole. Therefore, in the terminal block, even if there is a circumstance where the positioning pin cannot be passed through the first hole due to the fact that the first hole is open in the inclined direction, since the positioning pin can be passed through the second hole disposed near the first hole, positional accuracy of the first hole can be ensured.

(2) It is preferred that the terminal has a plate-like shape, and has an attachment portion through which the first hole extends in a plate thickness direction in the portion protruding outward from the one surface of the main body.

By inserting a fastening member through the first hole and fastening the fastening member, the attachment portion is attached to an attachment object. That is, the first hole can be a fastening hole for the fastening member. Note that, in details of the embodiments described later, the attachment portion is referred to as a first extension portion.

(3) It is preferred that the terminal has a third hole extending through a portion protruding outward from another surface different from the one surface of the main body, in one of the vertical direction and the horizontal direction. When insert molding is performed, after the positioning pin is passed through the second hole, a positioning member corresponding to the positioning pin can be passed through the third hole as well, and the terminal can be favorably positioned. Note that, in the details of the embodiments described later, the positioning member passed through the third hole is of a slide type.

(4) It is preferred that the main body has a primary molded portion having an opening and a secondary molded portion filling the opening, and the opening is positioned coaxially with the second hole and extends through the primary molded portion in the vertical direction.

When insert molding is performed, the terminal can be lowered toward a lower mold that forms the primary molded portion, and the positioning pin protruding from the lower mold can be passed through the second hole of the terminal. Therefore, assembly properties of the terminal with respect to the mold are improved. Although an opening is formed in the primary molded portion as the positioning pin is pulled out, the secondary molded portion fills the opening, and thus liquid tightness of the main body can be ensured.

### Details of Embodiments of Present Disclosure

A specific example of embodiments of the present disclosure will be described below with reference to the drawings. Note that the present disclosure is not limited to this example, but is indicated by the scope of the claims, and is intended to include all modifications within the meaning and scope equivalent to the scope of the claims.

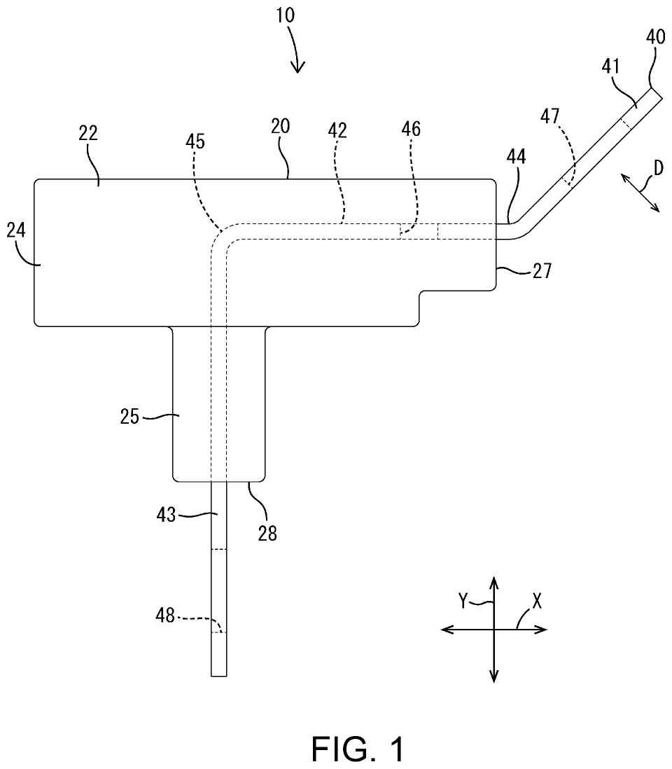

A terminal block 10 according to the present embodiment includes a main body 20 made of resin and a terminal 40 made of metal. As illustrated in FIG. 1, an intermediate portion of the terminal 40 is molded into and held integrally with the main body 20.

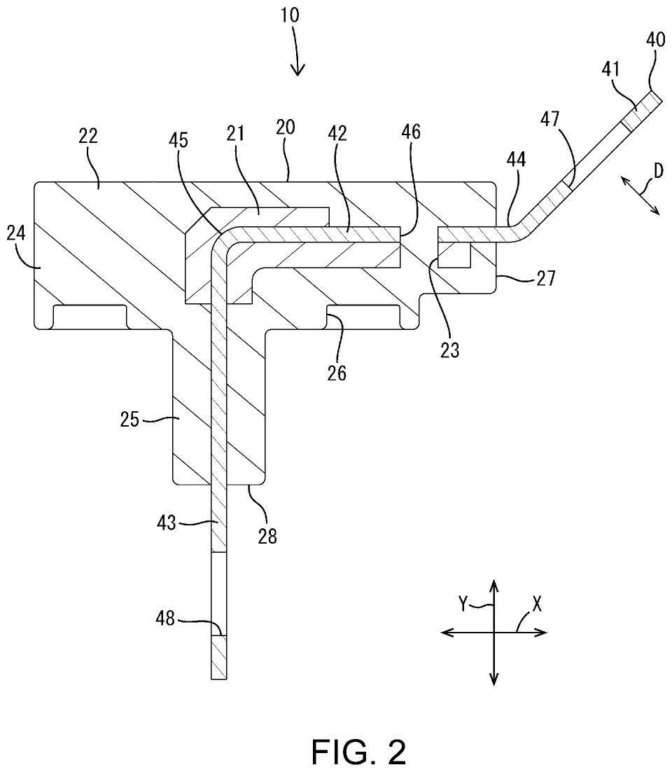

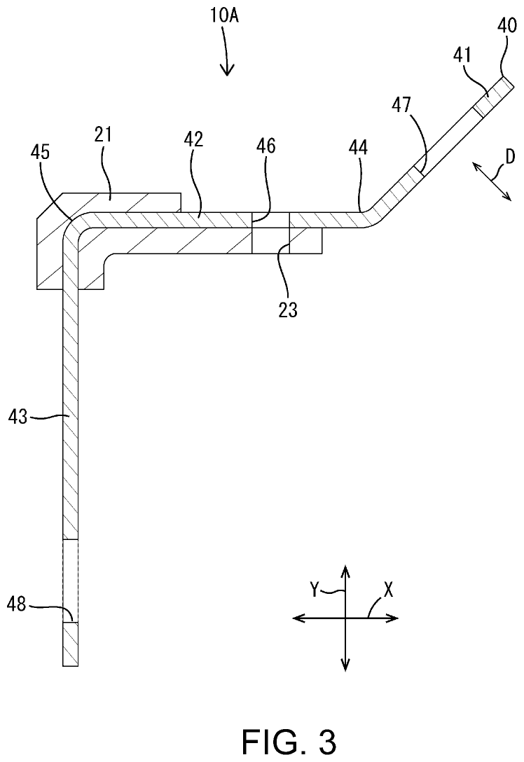

As illustrated in FIG. 2, the main body 20 includes a primary molded portion 21 (primary mold) and a secondary molded portion 22 (secondary mold) that covers the primary molded portion 21. The primary molded portion 21 and the terminal 40 are integrated through primary insert molding to form an intermediate assembly 10A illustrated in FIG. 3. The primary molded portion 21, the secondary molded portion 22, and the terminal 40 are integrated through secondary insert molding to form the terminal block 10 into a finished product illustrated in FIGS. 1 and 2.

In this specification, the term “insert molding” simply means the primary insert molding. In addition, an up-down direction is based on an up-down direction in each figure. The up-down direction is an extending direction of a third extension portion 43 of the terminal 40, which will be described later, and may also be referred to as a vertical direction Y The vertical direction Y corresponds to a moving direction of an upper mold 61, which will be described later. A left-right direction is based on a left-right direction in each figure. The left-right direction is an extending direction of a second extension portion 42 of the terminal 40, which will be described later, and is also referred to as a horizontal direction X. The horizontal direction X corresponds to a moving direction of a slide mold 63, which will be described later. The horizontal direction X and vertical direction Y are perpendicular to each other. The horizontal direction X and the vertical direction Y are not limited to a horizontal direction and a vertical direction in a strict sense, but are concepts that include errors in the respective moving directions of the upper mold 61 and the slide mold 63. Further, in this specification, an inclined direction D means a direction intersecting both the horizontal direction X and the vertical direction Y Specifically, the inclined direction D means a direction inclined at an angle other than a right angle with respect to both the horizontal direction X and the vertical direction Y The horizontal direction X, the vertical direction Y, and the inclined direction D are indicated by arrows in the drawings.

### Terminal

The terminal 40 is formed by bending a plate member made of conductive metal. Although not illustrated, a plurality of terminals 40 are molded into the main body 20 in parallel in the depth direction of the sheet of FIG. 1.

The terminal 40 has a shape extending continuously in a strip shape, and as illustrated in FIGS. 1 to 3, includes the second extension portion 42 extending in the horizontal direction X, a first extension portion 41 extending obliquely upward from a right end (one end) of the second extension portion 42 via one end bent portion 44, and the third extension portion 43 extending downward from a left end (the other end) of the second extension portion 42 via another end bent portion 45. The one end bent portion 44 connects an upper surface of the first extension portion 41 and an upper surface of the second extension portion 42 at an obtuse angle. The other end bent portion 45 connects the upper surface of the second extension portion 42 and a rear surface of the third extension portion 43 at a right angle.

The second extension portion 42 has a second hole 46. The second hole 46 has a circular cross-section and extends through the second extension portion 42 in the vertical direction Y, which is the plate thickness direction of the second extension portion 42. The second hole 46 is disposed in a portion of the second extension portion 42 spanning from the center of the second extension portion 42 in the left-right direction to the right end.

The first extension portion 41 has a first hole 47. The first hole 47 has a circular cross-section and extends through the first extension portion 41 in the inclined direction D, which is the plate thickness direction of the first extension portion 41. The first hole 47 has an opening diameter that is larger than that of the second hole 46. The first extension portion 41 is inclined in a direction perpendicular to an extension direction of the first hole 47.

A mating terminal (not illustrated) serving as an attachment object is assembled to the first extension portion 41 so as to overlap the first extension portion 41. The mating terminal has a hole that is in communication with the first hole 47 when assembled. A fastening member such as a bolt (not illustrated) is inserted into the first hole 47 of the terminal 40 and the hole of the mating terminal and fastened to electrically connect the terminal 40 and the mating terminal to each other. In this manner, the first extension portion 41 serves as the attachment portion (attachment) to which the mating terminal serving as the attachment object is to be attached. In addition, the first hole 47 serves as the fastening hole through which the fastening member is to be inserted.

The third extension portion 43 has a third hole 48. The third hole 48 has a circular cross-section and extends through the third extension portion 43 in the horizontal direction X, which is the plate thickness direction of the third extension portion 43. The third hole 48 is disposed at a lower end portion of the third extension portion 43. The opening diameter of the third hole 48 is the same as the opening diameter of the first hole 47. Similarly to the first hole 47, the third hole 48 also serves as a fastening hole through which a fastening member is to be inserted.

### Main Body

As illustrated in FIGS. 2 and 3, the primary molded portion 21 of the main body 20 covers a portion of the terminal 40 and is in close contact with the covered portion. Specifically, the primary molded portion 21 is in close contact with a portion extending from a lower surface of the second extension portion 42 excluding the right end thereof to a front surface on the upper end side of the third extension portion 43 and a portion extending from a left upper surface of the second extension portion 42 to a rear surface on the upper end side of the third extension portion 43. The primary molded portion 21 is in close contact with the other end bent portion 45 of the terminal 40, but is not in close contact with the peripheral edge portion of the opening of the second hole 46 on the upper surface of the second extension portion 42, and the peripheral edge portion of the opening of the second hole 46 is exposed at the stage of the intermediate assembly 10A.

Further, the primary molded portion 21 has an opening 23 extending through a portion in close contact with the lower surface of the second extension portion 42 in the vertical direction Y coaxially with the second hole 46. The opening 23 has a circular cross-section and is aligned with and is in communication with the second hole 46. The opening diameter of the opening 23 is the same as the opening diameter of the second hole 46.

As illustrated in FIG. 2, the secondary molded portion 22 of the main body 20 covers the entire outer surface of the primary molded portion 21 and is in close contact with the entire outer surface of the primary molded portion 21. The secondary molded portion 22 forms an outer shape of the main body 20 of the terminal block 10. The opening 23 of the primary molded portion 21 and the second hole 46 of the terminal 40 are filled with a resin portion of the secondary molded portion 22.

The secondary molded portion 22 has a base portion 24 that is elongated in the left-right direction, and a protrusion 25 protruding downward from a lower surface of the base portion 24. A seal groove 26 for mounting a seal ring (not illustrated) is provided in the lower surface of the base portion 24. Note that the terminal block 10 is attached to a case (not illustrated). The seal ring is fitted into the seal groove 26 to seal space between the main body 20 and the case in a liquid-tight manner.

Aright end surface of the base portion 24 is one surface 27 of the main body 20 and is disposed vertically in the up-down direction. The right end of the second extension portion 42 of the terminal 40 horizontally protrudes laterally from the one surface 27 of the main body 20. The first extension portion 41 and the one end bent portion 44 are exposed laterally from the one surface 27 of the main body 20.

A lower end surface of the protrusion 25 is another surface 28 of the main body 20 and is disposed horizontally in the left-right direction. The lower end portion of the third extension portion 43 of the terminal 40 vertically protrudes downward from the other surface 28 of the main body 20.

### Method for Manufacturing Terminal Block

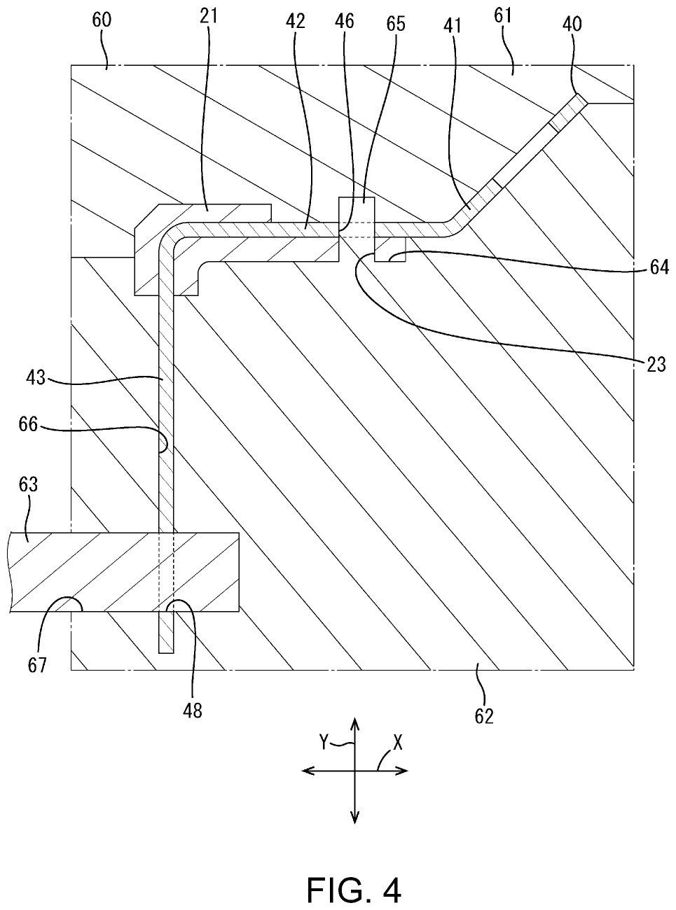

As illustrated in FIG. 4, a mold 60 for forming the intermediate assembly 10A of the terminal block 10 includes the upper mold 61, a lower mold 62, and the slide mold 63. The upper mold 61 is a movable mold that can move in the vertical direction Y The lower mold 62 is a fixed mold. A cavity is formed between the upper mold 61 and the lower mold 62.

The lower mold 62 has a positioning pin 65 protruding upward on a cavity forming surface 64 that is an upper surface of the lower mold 62. The positioning pin 65 can be fitted into the second hole 46 of the terminal 40. Further, the lower mold 62 has a slit 66 that extends in the vertical direction Y and is open to the cavity forming surface 64, and further has a guide portion 67 that extends in the horizontal direction X and intersecting the slit 66. The slide mold 63 is slidably disposed on the guide portion 67 of the lower mold 62.

When the terminal 40 is set in the mold 60, the slide mold 63 is retracted laterally and the upper mold 61 is retracted upward to open the mold 60, the third extension portion 43 of the terminal 40 is inserted into the slit 66 of the lower mold 62, and the positioning pin 65 is fitted into the second hole 46 of the second extension portion 42. The second hole 46 of the terminal 40 is positioned in the mold 60 by the positioning pin 65. Subsequently, the slide mold 63 is moved along the guide portion 67 and a leading end portion of the slide mold 63 is inserted into the third hole 48 of the third extension portion 43. The third hole 48 of the terminal 40 is positioned in the mold 60 by the slide mold 63.

Next, the upper mold 61 is lowered to close the mold 60, and the cavity formed in the mold 60 is filled with molten resin through injection. In this manner, insert molding is performed with the terminal 40 serving as an insert. After the molten resin has cooled and solidified, the slide mold 63 is moved laterally and the upper mold 61 is moved upward to open the mold 60, and a molded article is taken out. Thus, as illustrated in FIG. 3, the intermediate assembly 10A in which the primary molded portion 21 and the terminal 40 are integrated is obtained. Note that the opening 23 in communication with the second hole 46 is formed in the primary molded portion 21 of the intermediate assembly 10A by pulling out the positioning pin 65 when opening the mold. In the intermediate assembly 10A, since the other end bent portion 45 of the terminal 40 is molded by the primary molded portion 21, the terminal 40 is less likely to be deformed, and a relative positional relationship between the second hole 46 and the third hole 48 can be kept constant.

Subsequently, the intermediate assembly 10A is set in a secondary mold (not illustrated), and the intermediate assembly 10A is subjected to secondary insert molding. Thus, as illustrated in FIG. 2, the terminal block 10 is obtained as a finished product in which the second hole 46 and the opening 23 are filled with resin, and the surrounding region of the primary molded portion 21 is covered by the secondary molded portion 22.

In the case of the present embodiment, since the first hole 47 of the terminal 40 extends through the first extension portion 41 in the inclined direction D, when insert molding is performed, there are circumstances where it is difficult to pass the positioning pin 65 through the first hole 47. However, in the present embodiment, since the second hole 46 of the terminal 40 extends through the second extension portion 42 in the vertical direction Y, when insert molding is performed, the positioning pin 65 can be passed through the second hole 46. Since the first hole 47 of the terminal 40 is provided near the second hole 46, the first hole 47 can be positioned in the mold 60 together with the second hole 46 during insert molding. Therefore, the terminal block 10 obtained through this insert molding can maintain high positional accuracy of the first hole 47.

Further, the terminal 40 has the third hole 48 extending through the third extension portion 43 in the horizontal direction X. Therefore, when performing insert molding, after the positioning pin 65 has been passed through the second hole 46, the slide mold 63 can be passed through the third hole 48, and the terminal 40 can be favorably positioned.

Furthermore, since the opening 23 of the primary molded portion 21 is positioned coaxially with the second hole 46 and extends through the primary molded portion 21 in the vertical direction Y, when insert molding is performed, the terminal 40 can be lowered toward the lower mold 62, and the positioning pin 65 protruding from the lower mold 62 can be passed through the second hole 46 of the terminal 40. Therefore, the assembly properties of the terminal 40 with respect to the mold 60 are improved. Although the opening 23 is formed in the primary molded portion 21 as the positioning pin 65 is pulled out, since the secondary molded portion 22 fills the opening 23, when the terminal block 10 is attached to a case (not illustrated), the liquid tightness of the main body 20 can be ensured.

### Other Embodiments of the Present Disclosure

It should be considered that the above embodiment disclosed here are illustrative in all respects and not restrictive.

In the case of the above embodiment, the terminal has a shape that is bent via the other end bent portion. However, according to another embodiment, the terminal may have a shape extending in a straight line. When the terminal extends in a straight line, it is preferred that one surface and the other surface of the main body are arranged facing opposite sides.

In the case of the above embodiment, the extension direction of the second hole is set in the vertical direction. However, according to another embodiment, the extension direction of the second hole may be set horizontally. When the extension direction of the second hole is the horizontal direction, a portion of the terminal corresponding to the second extension portion may have a shape extending in the vertical direction.

In the case of the above embodiment, the extension direction of the third hole is set in the horizontal direction. However, according to another embodiment, the extension direction of the third hole may be set in the vertical direction. When the extension direction of the third hole is the vertical direction, a portion of the terminal corresponding to the third extension portion may have a shape extending in the horizontal direction.

In the above embodiment, the terminal has the third hole. However, according to another embodiment, the terminal does not need to have the third hole. Further, when the terminal does not have the third hole, the terminal does not need to have a portion protruding outward from the other surface of the main body.

In the case of the above embodiment, the secondary molded portion is in close contact with the primary molded portion so as to cover the entire primary molded portion. However, according to another embodiment, the secondary molded portion may be in close contact with a portion of the primary molded portion so as to cover the portion of the primary molded portion. For example, the secondary molded portion may include only a portion filling the opening of the primary molded portion.

In the case of the above embodiment, the opening of the primary molded portion and the second hole of the terminal are in communication with each other without a gap. However, according to another embodiment, the opening of the primary molded portion and the second hole of the terminal may be coaxially arranged so as to be spaced apart.

In the case of the above embodiment, the second hole of the terminal is closed by the secondary molded portion inside the main body. However, according to another embodiment, the second hole of the terminal may be disposed outside the main body. When the second hole is disposed outside the main body, the main body can have a structure without an opening, and can be formed through primary molding alone.

In the case of the above embodiment, the positioning pin is provided on the fixed lower mold. However, according to another embodiment, the positioning pin may be provided on the movable upper mold. Alternatively, the positioning pin may be provided on a positioning member separate from the lower mold and the upper mold. For example, the positioning member may be of a slide type.

1. A terminal block comprising:
a main body made of resin; and
a terminal partly molded into the main body,
wherein the terminal includes:
a first hole extending through a first portion that protrudes outward from one surface of the main body in an inclined direction intersecting both a vertical direction and a horizontal direction; and
a second hole extending through a second portion that spans from an inside of the main body to the first hole in one of the vertical direction and the horizontal direction.

2. The terminal block according to claim 1,
wherein the terminal has a plate shape, and has an attachment through which the first hole extends in a plate thickness direction in the first portion that protrudes outward from the one surface of the main body.

3. The terminal block according to claim 1,
wherein the terminal has a third hole extending through a third portion that protrudes outward from another surface different from the one surface of the main body, in either one of the vertical direction and the horizontal direction.

4. The terminal block according to claim 1, wherein:
the main body has a primary mold having an opening and a secondary mold that fills the opening, and
the opening is positioned coaxially with the second hole and extends through the primary mold in the vertical direction.
